(19) United States
(12) Patent Application Publication
(10) Pub. No.: US 2024/0422426 A1
(43) Pub. Date: Dec. 19, 2024

(54) MEDIA APPARATUS AND CONTROL METHOD AND DEVICE THEREOF, AND TARGET TRACKING METHOD AND DEVICE

(71) Applicant: SZ DJI TECHNOLOGY CO., LTD., Shenzhen (CN)

(72) Inventors: Pinxi MO, Shenzhen (CN); Yunfeng BIAN, Shenzhen (CN); Jianzheng GAO, Shenzhen (CN)

(21) Appl. No.: 18/818,516

(22) Filed: Aug. 28, 2024

Related U.S. Application Data
(63) Continuation of application No. PCT/CN2022/078679, filed on Mar. 1, 2022.

(51) Int. Cl. H04N 23/60; H04N 23/611; H04N 23/667; H04N 23/67; H04R 1/02; H04R 1/32; H04R 3/00

(52) U.S. Cl. CPC H04N 23/64; H04N 23/611; H04N 23/667; H04N 23/67; H04R 1/028; H04R 1/326; H04R 3/005; H04R 2499/11

(57) ABSTRACT

A control method includes determining position/orientation information of a target object according to an imaging position of the target object in an imaging view of a photographing device of a media apparatus, determining sound source position/orientation information according to ambient audio picked up by a sound pickup device of the media apparatus, and adjusting a photographing parameter of the photographing device and a sound pickup parameter of the sound pickup device according to the position/orientation information of the target object and the sound source position/orientation information, to focus an image captured by the photographing device and audio picked up by the sound pickup device on the target object.

### CROSS-REFERENCE TO RELATED APPLICATION

This application is a continuation of International Application No. PCT/CN2022/078679, filed Mar. 1, 2022, the entire content of which is incorporated herein by reference.

### TECHNICAL FIELD

The present disclosure relates to the field of video/audio processing and, more particularly, to a media apparatus and control method and device thereof, and a target tracking method and device.

### BACKGROUND

In practical applications, it is often needed to record audio and video of a target object. However, when recording audio and video, because of reasons such as movement of the target object, dark ambient lighting, or large background noise, it may be difficult for a photographing device or a sound pickup device to focus on the target object, resulting in poor audio and video recording effects.

### SUMMARY

In accordance with the disclosure, there is provided a control method including determining position/orientation information of a target object according to an imaging position of the target object in an imaging view of a photographing device of a media apparatus, determining sound source position/orientation information according to ambient audio picked up by a sound pickup device of the media apparatus, and adjusting a photographing parameter of the photographing device and a sound pickup parameter of the sound pickup device according to the position/orientation information of the target object and the sound source position/orientation information, to focus an image captured by the photographing device and audio picked up by the sound pickup device on the target object.

Also in accordance with the disclosure, there is provided a control device including at least one processor, and at least one memory storing at least one computer program that, when executed by the at least one processor, causes the control device to determine position/orientation information of a target object according to an imaging position of the target object in an imaging view of a photographing device of a media apparatus, determine sound source position/orientation information according to ambient audio picked up by a sound pickup device of the media apparatus, and adjust a photographing parameter of the photographing device and a sound pickup parameter of the sound pickup device according to the position/orientation information of the target object and the sound source position/orientation information, to focus an image captured by the photographing device and audio picked up by the sound pickup device on the target object.

Also in accordance with the disclosure, there is provided a media apparatus including a photographing device configured to collect an ambient image, a sound pickup device configured to pick up ambient audio, and a processor configured to determine position/orientation information of a target object according to an imaging position of the target object in an imaging view of a photographing device of a media apparatus, determine sound source position/orientation information according to ambient audio picked up by a sound pickup device of the media apparatus, and adjust a photographing parameter of the photographing device and a sound pickup parameter of the sound pickup device according to the position/orientation information of the target object and the sound source position/orientation information, to focus an image captured by the photographing device and audio picked up by the sound pickup device on the target object.

### BRIEF DESCRIPTION OF THE DRAWINGS

FIG. 1 is a schematic diagram showing a scenario of video/audio recording consistent with the present disclosure.

FIG. 2 is a flow chart of a control method of a media apparatus consistent with the present disclosure.

FIG. 3 is an overall flow chart of a parameter adjustment process consistent with the present disclosure.

FIG. 4 and FIG. 5 are schematic diagrams of a retrieval process of a target object consistent with the present disclosure.

FIG. 6 is a schematic diagram of a target object before and after retrieval consistent with the present disclosure.

FIG. 7A is a schematic diagram showing a display mode of a target object consistent with the present disclosure.

FIG. 7B is a schematic diagram showing a relationship between a distance of a target object and audio volume consistent with the present disclosure.

FIG. 7C is a schematic diagram showing an audio amplitude adjustment mode of different objects consistent with the present disclosure.

FIG. 8A and FIG. 8B are schematic diagrams showing scenarios resulting in the failure of audio focusing consistent with the present disclosure.

FIG. 9A is a flow chart of a target tracking method consistent with the present disclosure.

FIG. 9B is a schematic diagram showing a fusion process of audio information and image information consistent with the present disclosure.

FIG. 10A is a flow chart of a target tracking method using audio-assisted images consistent with the present disclosure.

FIG. 10B is a flow chart of a target tracking method using image-assisted audio consistent with the present disclosure.

FIG. 11 is a schematic structural diagram of a media apparatus consistent with the present disclosure.

FIG. 12 is a schematic structural diagram of a control device of a media apparatus and a tracking device of a target object consistent with the present disclosure.

### DETAILED DESCRIPTION OF THE EMBODIMENTS

The technical solutions of the present disclosure will be described below in conjunction with the drawings in the embodiments of the present disclosure. Obviously, the described embodiments are just some of the embodiments of the present disclosure, but not all of the embodiments. Based on the embodiments in this disclosure, all other embodiments obtained by those of ordinary skill in the art without creative work shall fall within the scope of this disclosure. The flow charts shown in the drawings are just illustrations, and do not necessarily include all contents and operations/steps, nor must they be performed in the order described. For example, some operations/steps can be decomposed, combined, or partly combined, so the actual order of execution may be changed according to the actual situation. The embodiments of the present disclosure will be described below in conjunction with the drawings in the embodiments of the present disclosure. In the case of no conflict, the following embodiments and features in the embodiments may be combined with each other.

The terminology used in this disclosure is for the purpose of describing particular embodiments only and is not intended to limit the scope of the present disclosure. As used in this disclosure and the appended claims, the singular forms including “a,” “the” are intended to include the plural forms as well, unless the context clearly dictates otherwise. It will also be understood that the term “and/or” as used herein refers to and includes any and all possible combinations of one or more of the associated listed items.

Although the terms first, second, third, etc. may be used in this disclosure to describe various information, the information should not be limited to these terms. These terms are only used to distinguish information of the same type from each other. For example, without departing from the scope of the present disclosure, the first information may also be called the second information, and similarly, the second information may also be called the first information. Depending on the context, the word “if” as used herein may be interpreted as “when” or “while” or “in response to determining.”

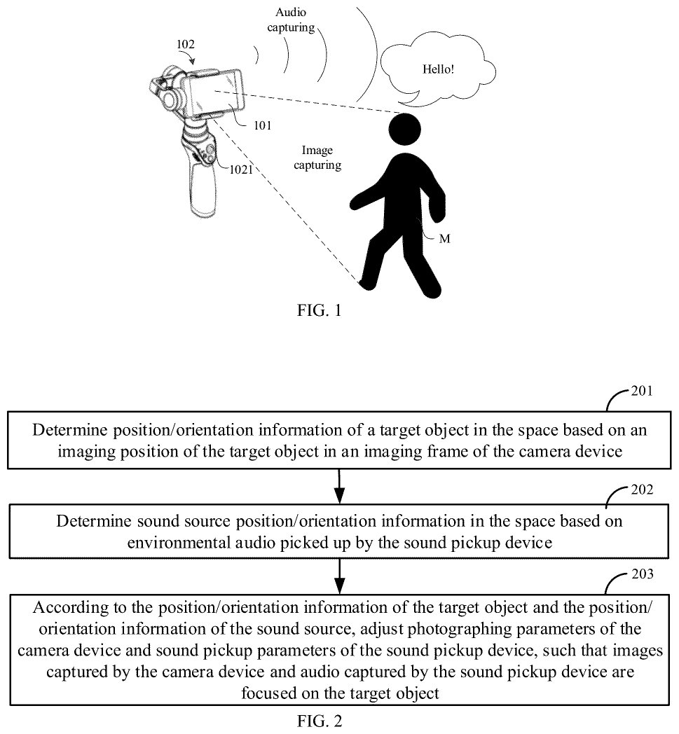

In practical applications, it is often needed to record audio and video of target objects. FIG. 1 shows a schematic diagram showing an audio and video recording scenario. The space may include one or more target objects M, where the one or more target objects M may include various types of living or non-living objects such as people, animals, vehicles, electronic devices, etc. In some embodiments, one target object may be able to move autonomously, or may follow the movement of other objects. Typically, the target object may emit audio signals. For example, when the target object is a person, the audio signal may be the person's voice (for example, “Hello!”). When the target object is a vehicle, the audio signal may be the sound of the vehicle's engine when the vehicle is driving, the sound of the vehicle's horn, etc. Audio and video recording may be performed on the target object through a media apparatus 101.

In some embodiments, the media apparatus 101 may include a photographing device and a sound pickup device (not shown in the figure). The photographing parameters (for example, attitude, focal length, etc.) of the photographing device may change as target object M moves, to focus on target object M and capture an image sequence of the target object M, thereby achieving video recording of the target object. The sound pickup device may include a microphone array, such as a linear array, a planar array, or a three-dimensional array. The sound pickup device may be able to collect the audio information of the target object, thereby achieving audio recording of the target object. Furthermore, to improve the audio recording effect, the sound pickup device may also adjust sound pickup parameters to perform directional recording of the audio information of the target object. Through video recording and audio recording, audio and video recording may be realized together. In the embodiment shown in FIG. 1, the media apparatus 101 is a mobile phone, which is mounted at a handheld gimbal 102. By controlling the rotation of a rotation shaft, the attitude adjustment of the media apparatus 101 may be achieved. The handheld gimbal may also include one or more buttons 1021 to adjust other photographing parameters of the photographing device and/or the sound pickup parameters of the sound pickup device.

The embodiment shown in FIG. 1 is only used as an example to illustrate the video/audio recording scenario of the present disclosure, and is not intended to limit the scope of present disclosure. Audio and video recording scenarios in practical applications are not limited to the scenarios described in the above embodiments. Further, the type, mounting location, control method, etc. of the media apparatus 101 are not limited to those described in the above embodiments.

During the video/audio recording process, the video/audio recording effect may be affected by many factors. On the one hand, the video/audio recording effect may be affected by factors including the intensity of ambient light, the moving speed of the target object, and/or the occlusion of the target object. Specifically, when the ambient light intensity is weak, the detection accuracy of the target object from the imaging views may decrease, making it difficult to accurately determine the location of the target object. When the target object moves too fast, it may be difficult to switch the photographing parameters to follow the target object, and may be easy to lose the target object in the imaging views. When the target object is occluded, the captured target object may be often incomplete. On the other hand, the audio recording effect may be affected by environmental noise. When the environmental noise is too loud, it may be difficult to accurately capture the audio information associated with the target object. Further, users may inadvertently block one or more microphones in the microphone array when operating the media apparatus, causing some microphones to become unavailable and therefore reducing the audio recording effect. In addition to the above situations, when the focus is blurred, the target object is not in the imaging view, the target object does not make a sound or the sound is low, there are multiple sound targets, or there is strong interference sound, the photographing device or the sound pickup device may be also difficult to focus on the target object, resulting in poor audio and video recording results.

The present disclosure provides a control method of a media apparatus, to at least partially alleviate the above problems. The media apparatus may include a photographing device and a sound pickup device. As shown in FIG. 2, the method includes:
201: determining position/orientation information of a target object in the space based on an imaging position of the target object in an imaging view of the photographing device;
202: determining sound source position/orientation information in the space based on ambient audio picked up by the sound pickup device; and
203: according to the position/orientation information of the target object and the sound source position/orientation information, adjusting photographing parameters of the photographing device and sound pickup parameters of the sound pickup device, such that images captured by the photographing device and audio captured by the sound pickup device are focused on the target object.

The media apparatus in the embodiments of the present disclosure may be any electronic device including a photographing device and a sound pickup device, such as a mobile phone, a camera with a recording function, etc. The photographing device and the sound pickup device may be visually separated devices (for example, they may be mounted at two different devices), or they may be integrated, like a mobile phone. In the present disclosure, information from two dimensions of sound and images may be used to adjust the photographing parameters and sound pickup parameters, thereby improving the accuracy and robustness of the adjustment results.

At 201, the surrounding environment may be imaged by the photographing device. When the target object is within the field of view of the photographing device, the target object may be included in the imaging view of the photographing device. By performing target definition, target feature extraction, target identification, or other operations on the imaging view, the pixel position of the target object in the imaging view may be determined. An image coordinate system may be established in advance, and the image coordinate system may be a coordinate system that is stationary relative to the photographing device. The imaging position may be represented by coordinates in the image coordinate system. The position/orientation information of the target object in space may be represented by the coordinates of the target object in a physical coordinate system (for example, a world coordinate system or another coordinate system that is stationary relative to the media apparatus). Assuming that the imaging position of the target object in the imaging view (that is, the pixel position of the target object) is pₒ, based on the pose information and pₒ during imaging of the photographing device, a mapping relationship between the image coordinate system and the physical coordinate system may be determined to determine the position/orientation information Pₒ of the target object in the space (i.e., the physical position/orientation of the target object). The photographing device may include one or more cameras, which may be used to perform continuous imaging to obtain multiple consecutive imaging views. Subsequently, the real-time position/orientation information of the target object in the space may be obtained based on the above method.

At 202, the sound pickup device may capture various ambient audio and determine the sound source position/orientation information in the space based on the captured ambient audio. For example, in some embodiments, the sound field coordinate system may be established in advance, and the sound field coordinate system may be generally a coordinate system that is stationary relative to the sound pickup device. The sound field signals of two or more microphones may be obtained by using the microphone array in the sound pickup device, and then sound source positioning technology may be used to determine the real-time position/orientation of the sound source in the sound field coordinate system. The sound source positioning technology may include, but is not limited to, beamforming technology, differential microphone array technology, time difference of arrival (TDOA) technology, etc. Subsequently, based on the mapping relationship between the sound field coordinate system and the physical coordinate system, the real-time position/orientation of the sound source in the sound field coordinate system may be mapped to obtain the real-time position/orientation of the sound source in the physical coordinate system.

The ambient audio may be emitted by the target object or by other objects other than the target object. That is, the sound source in the space may include the target object or other objects other than the target object. Therefore, the ambient audio captured by the sound pickup device may include the following situations: (1) the ambient audio only includes audio signals emitted by the target object; (2) the ambient audio only includes audio signals emitted by other objects other than the target object; (3) the ambient audio includes the audio signals emitted by the target object and also the audio signals emitted by other objects other than the target object. That is, the sound source position/orientation information determined in this step may be the same as, or may be different from, the position/orientation information of the target object in space determined at 201.

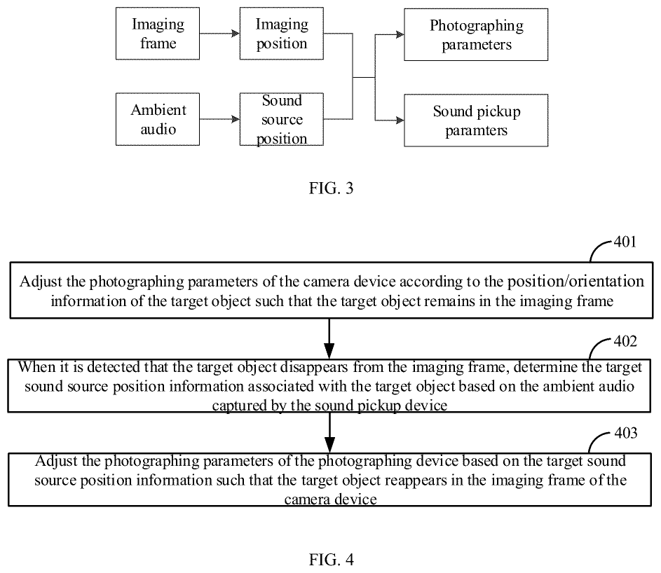

At 203, the photographing parameters of the photographing device may be adjusted jointly based on the position/orientation information of the target object and the sound source position/orientation information, and the sound pickup parameters of the sound pickup device may be adjusted jointly based on the position/orientation information of the target object and the sound source position/orientation information. For example, as shown in FIG. 3, the position/orientation information of the target object and the sound source position/orientation information may be fused to obtain the fused position/orientation information, and the photographing parameters of the photographing device and the sound pickup parameters of the sound pickup device may be adjusted according to the fused position/orientation information.

In existing technologies, when recording audio and video, the photographing parameters of the photographing device are often adjusted based only on the position/orientation information of the target object, and the sound pickup parameters of the sound pickup device are usually adjusted based on the sound source position/orientation information. Compared with the adjustment methods in the existing technologies, the adjustment method of the present disclosure may have higher accuracy and reliability, such that the images captured by the photographing device and the audio captured by the sound pickup device may better focus on the target object to improve the audio and video recording effects. Focusing described in this disclosure does not necessarily mean focusing on the target object. It may also mean making the lens of the photographing device follow the target object such that the target object is always in the imaging view of the photographing device. It may also mean adjusting the sound pickup parameters of the sound pickup device such that the audio of the target object captured by the sound pickup device has a higher signal-to-noise ratio.

In some embodiments, the target object may be lost from the imaging view during the audio and video recording process. In this case, it is difficult for existing technologies to effectively retrieve the target object. The present disclosure may use the sound source position/orientation information as an auxiliary positioning manner to realize the relocation of the target object when it is lost from the imaging view, and use this as a basis to adjust the photographing parameters of the photographing device to make the target object reappear in the imaging view.

As shown in FIG. 4, the photographing parameters of the photographing device may be adjusted according to the position/orientation information of the target object such that the target object remains in the imaging view (401). When it is detected that the target object disappears from the imaging view of the photographing device, the target sound source position/orientation information associated with the target object may be determined based on the ambient audio captured by the sound pickup device (402). The photographing parameters of the photographing device may be adjusted based on the target sound source position/orientation information such that the target object reappears in the imaging view of the photographing device (403). When there are the target object and other sound sources in the environment, the target sound source position/orientation information may be determined from multiple pieces of sound source position/orientation information. Therefore, in the present embodiment, an extensive search through audio may be performed when the target object is lost in the imaging view to obtain the positions/orientations of multiple sound sources, and then the most likely position/orientation of the target object may be determined and focus may be performed on the target object based on this position/orientation.

In some embodiments, for example, the position/orientation information of the target object at multiple moments may be obtained, and the position/orientation information at each moment may be determined based on the imaging position of the target object in the imaging view at that moment. The multiple moments may include the current moment and at least one historical moment, or may only include multiple historical moments without including the current moment. The moving speed and moving direction of the target object may be determined based on the position/orientation information at the multiple moments, and the photographing parameters of the photographing device may be adjusted based on the moving speed and moving direction. For example, the photographing angle of the photographing device may be adjusted based on the movement direction. Assuming that the target object moves to the right relative to the photographing device, the photographing angle of the photographing device may be adjusted to the right. Assuming that the target object moves toward the edge of the imaging view, the focus of the photographing device may be adjusted. The adjustment amount of the photographing angle may be determined based on the movement speed. In some examples, the adjustment amount of the photographing angle may be positively related to the movement speed.

In other embodiments, other methods may also be used to adjust the photographing parameters of the photographing device, which are not listed here. The purpose of adjustment may be to keep the target object in the imaging view. However, in practical applications, the adjustment process may not be accurate enough, failing to keep the target object in the imaging view, that is, the target object may disappear in the imaging view. At this time, the target sound source position/orientation information associated with the target object may be determined based on the ambient audio captured by the sound pickup device.

The space may include sound sources other than the target object. Therefore, it may be needed to locate the target sound source associated with the target object from each sound source, that is, the sound source of the target object. For example, the space may include human voices, vehicle starting sounds, and music sounds. When the target object is a person, it may be needed to locate the target sound source that emits the human voice from various sound sources.

In some embodiments, the target sound source position/orientation information associated with the target object may be determined based on audio feature information of the sound sources in the space. The audio feature information of an object's sound source may be related to the category and/or attributes of the object. The correspondence between the audio feature information and the category and/or attributes of the object may be established in advance. The target sound source may be determined based on the correspondence and the category and attributes of the target object, further, the target sound source position/orientation information may be determined. The categories may include but are not limited to people, animals, vehicles, etc., and the attributes may include but are not limited to gender, age, model, etc.

In some embodiments, the audio feature information may include the frequency of audio. When the frequency of audio emitted by a sound source is within the target frequency band, the target sound source position/orientation information associated with the target object may be determined based on the position/orientation information of the sound source. The target frequency band range may be determined based on the category and/or attributes of the target object. For example, the frequency of an adult man's voice is generally between 200 Hz and 600 Hz. Therefore, when the target object is an adult man and the frequency of the audio emitted by a sound source is between 200 Hz and 600 Hz, the sound source may be determined to be the target sound source associated with the target object, and the position/orientation information of the sound source may be determined as the target sound source position/orientation information.

In some embodiments, the audio feature information may include amplitudes of audio. When the amplitude of the audio emitted by a sound source meets a preset amplitude condition, the target sound source position/orientation information associated with the target object may be determined based on the position/orientation information of the sound source. The preset amplitude condition may include that the audio amplitude is within a preset range, or that the audio amplitude is the largest, or other conditions. When the preset amplitude condition includes that the audio amplitude is the largest and the amplitude of the audio emitted by a sound source is the largest, the sound source may be determined to be the target sound source associated with the target object, and the position/orientation information of the sound source may be determined as the target sound source position/orientation information. Particularly, in a case where multiple objects are included and only one object emits audio signals, the object emitting the audio signals may be determined as the target object.

In some embodiments, the audio feature information may include semantic information of audio. When a sound source emits audio with preset semantic information, the target sound source position/orientation information associated with the target object may be determined based on the position/orientation information of the sound source. Semantic analysis may be performed on the audio emitted by various sound sources in the space to determine the semantic information included in the audio. The preset semantic information may be determined based on the scene in which the media apparatus is located. For example, in a teaching scene, it may be assumed that the target object is a teacher. When a sound source that emits the semantic information “Begin class” and a sound source that emits the semantic information “Good teacher” are identified, the sound source that emits the semantic information “Begin class” may be determined as the target sound source associated with the target object, and the position/orientation information of the sound source may be determined as the target sound source position/orientation information.

In other embodiments, audio feature information may include at least two of frequency, amplitude, or semantic information. Correspondingly, at least two of frequency, amplitude, and semantic information may be combined to determine the target sound source, thereby determining the target sound source location information.

After the target sound source location information is determined, the photographing parameters of the photographing device may be adjusted again. For example, the angle of the camera may be adjusted to face the target sound source, or the focal length of the camera may be reduced to expand the field of view of the camera such that the target object reappears in the imaging view of the camera.

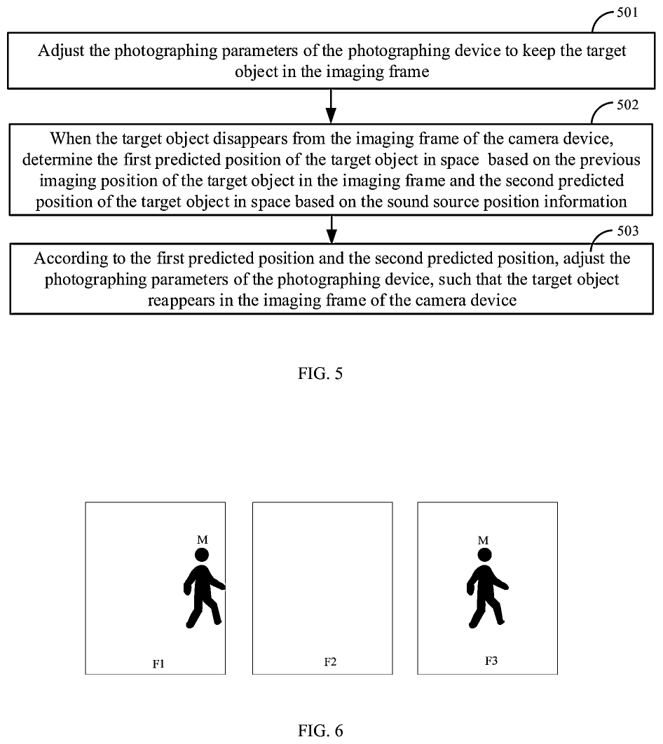

Another embodiment of the present disclosure as shown in FIG. 5 provides another method for retrieving the target object. As shown in FIG. 5, the photographing parameters of the photographing device may be adjusted according to the target object position/orientation information such that the target object remains in the imaging view (501). When it is detected that the target object disappears from the imaging view of the photographing device, a first predicted position/orientation of the target object in the space may be determined based on the imaging position of the target object in the imaging view before disappearing from the imaging view, and a second predicted position/orientation of the target object in the space may be determined based on the sound source position/orientation information (502). The photographing parameters of the photographing device may be adjusted according to the first predicted position/orientation and the second predicted position/orientation, such that the target object reappears in the imaging view of the photographing device (503).

The implementation of 501 may be similar to 401 and will not be described again here. The following mainly describes 502 and 503. At 502, the first predicted position/orientation may be determined based on one or more recent imaging positions of the target object in the imaging view before the target object disappears from the imaging view. For example, when the n-th imaging view collected by the photographing device includes the target object and the (n+1)-th imaging view does not include the target object, the first predicted position/orientation may be determined based on the pixel position of the target object in the n-th imaging view.

Alternatively, in another embodiment, the first predicted position/orientation may be determined based on the pixel position of the target object in each of the n-th to (n−k)-th imaging views, where k is a positive integer. The second predicted position/orientation may be determined based on the sound source position/orientation information determined most recently.

At 503, the photographing parameters may be adjusted based on the combination of the first predicted position/orientation and the second predicted position/orientation. For example, in some embodiments, the area where the target object is located in the space may be predicted based on the first predicted position/orientation and the second predicted position/orientation to obtain the predicted area, and the photographing parameters of the photographing device may be adjusted based on the position/orientation of the predicted area. Specifically, in some embodiments, the first predicted position/orientation and the second predicted position/orientation may be weighted to obtain the target predicted position/orientation, and the prediction area may be determined based on the target predicted position/orientation. Alternatively, in another embodiment, one of the first predicted position/orientation and the second predicted position/orientation with higher confidence may be used as the target predicted position/orientation, and the prediction area may be determined based on the target predicted position/orientation. In other embodiments, other methods may also be used to determine the target predicted position/orientation, which will not be listed here. Subsequently, the photographing angle of the photographing device may be adjusted such that the photographing device is facing the prediction area, or the focal length of the photographing device may be reduced such that the prediction area falls within the field of view of the photographing device.

As shown in FIG. 6, target object M is located at the right edge of the imaging view of imaging view F1, and the target object is lost in imaging view F2. By adopting the retrieval method in the embodiment shown in FIG. 4 or FIG. 5, the target object is retrieved again such that the target object reappears in imaging view F3. In some application scenarios, after the target object is lost from the imaging view, the target object may be controlled to emit an audio signal to retrieve the target object.

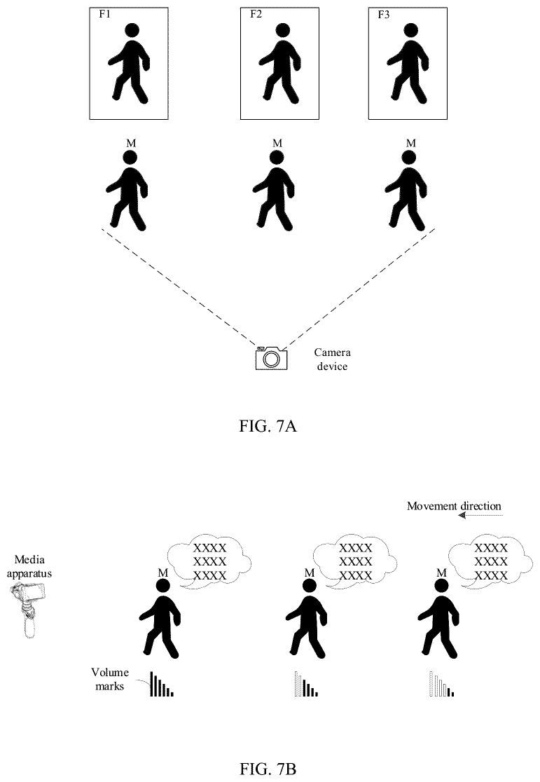

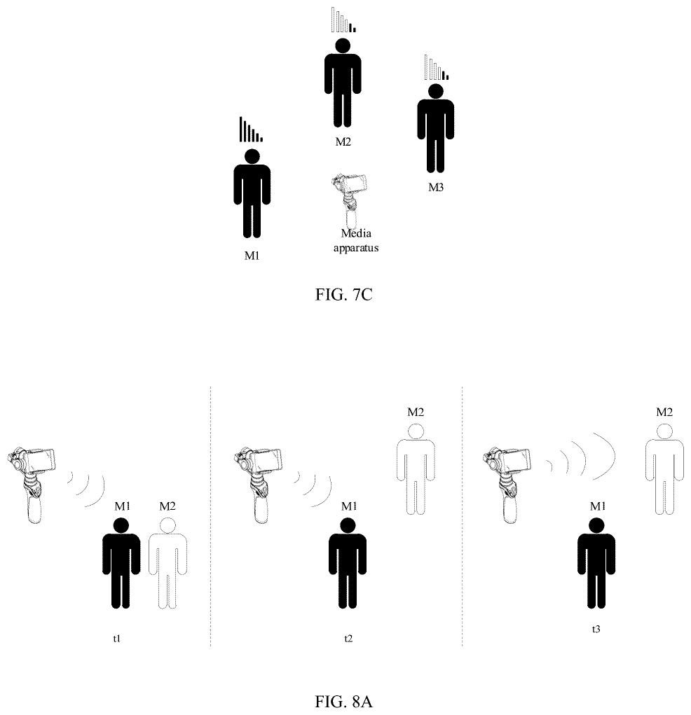

In some embodiments, by adjusting the photographing parameters of the photographing device and/or the sound pickup parameters of the sound pickup device, specific audio and video recording effects may also be obtained. For example, the photographing parameters of the photographing device may be adjusted so that the target object is located in a designated area in the imaging view. The designated area may be the center area of the imaging view, or the upper right corner of the imaging view, or the lower left corner of the imaging view. Or, the target object may be displayed in other areas of the imaging view according to an arbitrarily set composition method. FIG. 7A shows a schematic diagram in which the target object is fixedly displayed in the center area of the imaging view. It can be seen that in the process of target object M moving from right to left, the photographing device may perform imaging three times in total, and obtain the imaging views F1, F2, and F3 respectively. In the imaging views F1, F2, and F3, target object M is all located in the center area of the corresponding imaging view.

In another embodiment, the sound pickup parameters of the sound pickup device may be adjusted such that the audio captured by the sound pickup device matches the distance from the target object to the media apparatus. The matching may be positive correlation, anti-correlation, or other corresponding relationships. As shown in FIG. 7B, target object M is moving toward the media apparatus while speaking, and the moving direction is shown by the arrow in the figure. In the figure, the volume of the audio signal is represented by a set of columnar volume marks, and the number of black columnar marks represents the volume of the recorded audio signal. It can be seen that as target object M gradually approaches the media apparatus, the sound pickup parameters may be adjusted such that the volume (i.e., amplitude) of the recorded audio signal gradually increases.

In another embodiment, the audio of the target object may be directionally picked up. That is, by adjusting the sound pickup parameters of the sound pickup device to enhance the amplitude of the audio of the target object and weaken the amplitude of other audios except the audio of the target object. Therefore, target sounds with a high signal-to-noise ratio may be obtained. Especially, when the audio amplitude of the target object is lower than the audio amplitude of other objects, through directional sound pickup, a better sound pickup effect may be obtained. The degree of enhancement and/or attenuation may be determined according to actual needs, for example, according to instructions input by the user. As shown in FIG. 7C, M1 is the target object, while M2 and M3 are objects other than the target object. The volume of the recorded audio signal of M1 may be enhanced by adjusting the sound pickup parameters, and the volume of the recorded audio signals of M2 and M3 may be attenuated.

In some embodiments, the image captured by the photographing device may be out of sync with the ambient audio captured by the sound pickup device. For example, the collection frequency of ambient audio may be f1, the imaging frequency of the photographing device may be f2, and f1+f2. In this case, the ambient audio and imaging views collected at the same time may be filtered out. Then, the filtered imaging views may be used to determine the imaging position at 201, and the filtered ambient audio may be used to determine the sound source position/orientation information at 202. Alternatively, in some other embodiments, the imaging position at the second moment may be predicted based on the imaging view at the first moment, and the sound source position/orientation information may be determined based on the ambient audio collected at the second moment. The photographing parameters and the sound pickup parameters may be adjusted based on the imaging position at the second moment and the sound source position/orientation information at the second moment.

In some other embodiments, the imaging position at 201 may be determined based on the most recently obtained imaging view including the target object. Since the time interval between the most recently obtained imaging view including the target object and the real-time collected ambient audio is generally small, the method of this embodiment may obtain higher accuracy while eliminating the computing power required for the required synchronization process and reducing the processing complexity.

In some embodiments, the target object may be recorded based on the audio recording mode selected by the user, and the sound pickup parameters of the sound pickup device may be adjusted in real time according to the target object position/orientation information and the sound source position/orientation information in the audio recording mode. Each recording mode may correspond to an adjustment method of the sound pickup parameters. For example, in a first recording mode, the sound pickup parameters may be adjusted to enhance the amplitude of the audio of the target object and to weaken the amplitude of audio other than the audio of the target object. In a second recording mode, the sound pickup parameters may be adjusted such that the audio captured by the sound pickup device matches the distance from the target object to the media apparatus. In a third recording mode, the sound pickup parameters may be adjusted so that the amplitude of the audio captured by the sound pickup device is fixed. In addition to the recording modes listed above, users may also choose other recording modes according to their needs, which will not be listed here.

In other embodiments, the target object may also be photographed based on the photographing mode selected by the user, and in the photographing mode, the photographing parameters of the photographing device may be adjusted in real time according to the target object position/orientation information and the sound source position/orientation information.

Each photographing mode may correspond to an adjustment method of the photographing parameters. For example, in a first photographing mode, the photographing parameters may be adjusted such that the target object is in a designated area in the imaging view. In a second photographing mode, the photographing parameters may be adjusted such that the ratio between the number of pixels occupied by the target object in the imaging view and the total number of pixels in the imaging view is equal to a fixed value. In a third photographing mode, the photographing parameters may be adjusted such that the size of the target object in the imaging view is fixed. In addition to these photographing modes listed above, users may also choose other photographing modes according to their needs, which will not be listed here.

In some embodiments, the sound pickup parameters of the sound pickup device may be adjusted according to the sound source position/orientation information, such that the captured audio focuses on the target object. When the target object position/orientation information changes, the sound pickup parameters of the sound pickup device may be adjusted based on the changed position/orientation information of the target object, such that the captured audio is refocused on the target object.

In some scenarios, the position/orientation of the target object may change, but the sound pickup device cannot accurately determine the position/orientation of the target object for some reason, resulting in the sound pickup device failing to focus on the target object. As shown in FIG. 8A, there are two objects M1 and M2 in the space at time t1. M2 is the target object and M1 belongs to other objects except the target object. At time t1, the sound pickup parameters may be adjusted to make the sound pickup device focus on M2. Since the audio features of M1 and M2 are similar and the locations of M1 and M2 are close, the sound pickup device may not be able to distinguish the audio of M1 from the audio of M2. Therefore, at time t2, when the position/orientation of M2 changes, the sound pickup device may mistakenly determine M1 as the target object and still use the same sound pickup parameters to capture audio, causing the sound pickup process to fail to focus on the target object M2. To reduce the above situation, the photographing device may be used to assist the sound pickup device in capturing audio. That is, the position/orientation information of the target object M2 in space may be determined based on the imaging position of the target object M2 in the imaging view of the photographing device. According to the position/orientation information, it may be known that the position/orientation information of M2 at time t1 is different from the position/orientation information of M2 at time t2. Therefore, at time t3, the sound pickup parameters of the sound pickup device may be adjusted according to the changed position/orientation information of M2, such that the captured audio is refocused on M2.

In other embodiments, different locations in the space may include different objects, and the audio features of these objects may be similar, making it difficult for the sound pickup device to accurately determine the target object from these objects, and thus it may be difficult to accurately focus on the target object. As shown in FIG. 8B, there are two objects M1 and M2 in the space, where M2 is the target object. However, since the sound features of M1 and M2 are relatively similar, the sound pickup device mistakenly determines that M1 is the target object, and thus focuses on M1 at time t1. To reduce the above situation, the imaging view based on the photographing device may be obtained to obtain the position/orientation information of M1 and M2, and the sound pickup parameters may be adjusted based on the position/orientation information of M1 and M2, such that the sound pickup device focuses on M2 at time t2.

In some embodiments, when at least any of the following conditions is met, the steps for adjusting the sound pickup parameters of the sound pickup device based on the changed position/orientation information of the target object such that the captured audio is refocused on the target object when the position/orientation information of the target object is changed: (1) at least one microphone included in the sound pickup device is unavailable, or (2) the amplitude of the background noise is larger than a preset amplitude threshold. When at least one of the above conditions is met, the accuracy of the sound pickup device in distinguishing the audio signal of the target object may be reduced. Therefore, the photographing device may be used to assist the sound pickup device in picking up sound, thereby improving the adjustment effect of the sound pickup parameters and improving the audio/video recording effects. That at least one microphone is unavailable may be because the at least one microphone is blocked or damaged. Background noise may be audio from objects other than the target object, or it may be wind noise or other noise. The amplitude threshold may be a fixed value, or may be dynamically set according to the amplitude of the audio signal of the target object, for example, may be set to several times the amplitude of the audio signal of the target object.

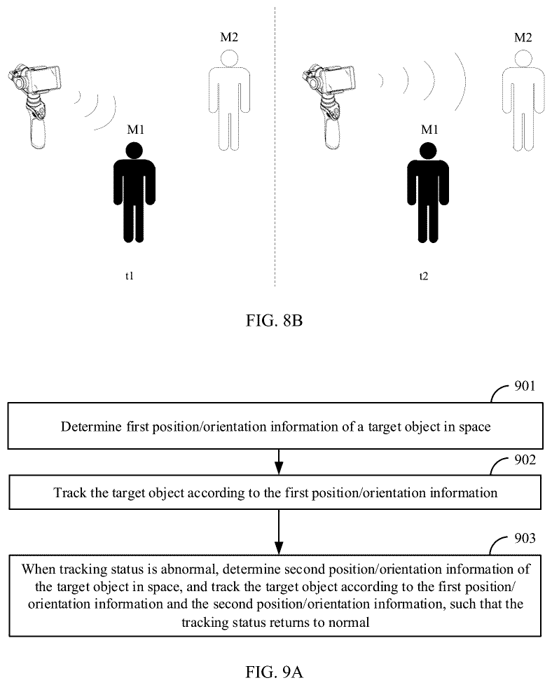

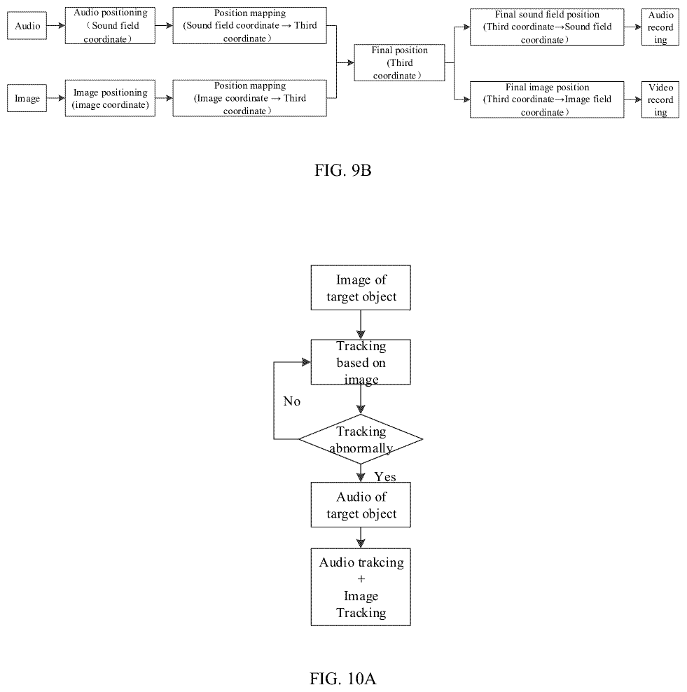

The present disclosure also provides a target tracking method. As shown in FIG. 9A, in some embodiments, the method includes:
901: determining first position/orientation information of a target object in space;
902: tracking the target object according to the first position/orientation information; and
903: in response to an abnormal tracking status, determining second position/orientation information of the target object in space, and tracking the target object according to the first position/orientation information and the second position/orientation information, such that the tracking status returns to normal.

Through the fusion of audio and image information, target positioning and tracking may be better achieved. The specific fusion process is introduced below.

As shown in FIG. 9B, the fusion process includes:
(1) According to the audio of the target object, obtaining the audio position/orientation of the target object, that is, the real-time position/orientation of the target object in the sound field coordinate system.
(2) According to the image information, obtaining the image position/orientation of the target object, that is, the real-time pixel position of the target object in the image coordinate system.
(3) Establishing the mapping relationship, as well as the inverse mapping relationship, between the sound field coordinate system and the image coordinate system to the third coordinate system. The third coordinate system may be a coordinate system that is stationary relative to the media apparatus. When the sound pickup device/photographing device is mounted at a stationary position relative to the media apparatus, the sound field coordinate system or the image coordinate system is also stationary relative to the third coordinate system, that is, the space mapping relationship from the sound field coordinate system or the image coordinate system to the third coordinate system may be fixed. When the sound pickup device or the photographing device is mounted at a kinematic mechanism that moves relative to the media equipment, such as a gimbal, then the sound field coordinate system or the image coordinate system may also move relative to the third coordinate system, that is, the space mapping relationship from the sound field coordinate system or the image coordinate system to the third coordinate system may change with the change of the attitude of the kinematic mechanism.
(4) Position mapping. According to the real-time position/orientation of the target object in the sound field coordinate system and the mapping relationship between the sound field coordinate system and the third coordinate system, the position/orientation of the target object in the third coordinate system (Position/orientation 1) may be determined. According to the real-time pixel position of the target object in the image coordinate system and the mapping relationship between the image coordinate system and the third coordinate system, the position/orientation of the target object in the third coordinate system (Position/orientation 2) may be determined.
(5) Determining the final position/orientation of the target object in the third coordinate system. Position/orientation 1 and position/orientation 2 may be weighted and the final position/orientation may be determined based on the weighted results. Further, the final position/orientation may be determined by combining Position/orientation 1, Position/orientation 2, and at least any of the confidence of Position/orientation 1, the confidence of Position/orientation 2, the final position/orientation determined historically, or the motion model of the target object. The confidence of Position/orientation 1 may be determined based on factors such as the number of available microphones, the amplitude of background noise, the number of objects whose distance from the target object is less than a preset distance threshold, or other factors. The confidence of Position/orientation 2 may be determined based on factors such as the intensity of ambient light, the moving speed of the target object, or whether the target object is blocked. Historically determined final position/orientation may include the most recently determined final position/orientation or positions/orientations. The motion model of the target object may be a uniform velocity model, a uniform acceleration model, a uniform deceleration model, etc. The motion process of the target object may be segmented and the motion model of each segment may be selected.
(6) Determining the final position/orientation of the target object in the sound field coordinate system and in the image coordinate system respectively. According to the final position/orientation of the target object in the third coordinate system and the mapping relationship between the third coordinate system and the sound field coordinate system (that is, the inverse mapping relationship between the sound field coordinate system and the third coordinate system), the final position/orientation of the target object in the sound field coordinate system may be determined. final position/orientation. According to the final position/orientation of the target object in the third coordinate system and the mapping relationship from the third coordinate system to the image coordinate system (that is, the inverse mapping relationship between the image coordinate system and the third coordinate system), the final position/orientation of the target object in the image coordinate system may be determined.
(7) According to the specific needs of recording or photographing, performing specific recording or photographing on the target object. For example, when recording, the directional sound pickup technology of the microphone array may be used to record the target object with a high signal-to-noise ratio, or the sound pickup device connected to the gimbal may be controlled through the gimbal to pick up the sound of the target object. When photographing, through the gimbal control, the photographing device connected to the gimbal may be turned to the target direction to complete operations such as composition or focusing. The user may also be prompted on the display side of the media apparatus to move or rotate the media apparatus to better complete the audio and video recording.

For products with a photographing device having a limited viewing angle (for example, no more than) 180°, the solutions of the embodiments of the present disclosure may have a significant improvement in target recognition performance. When the target object is outside the viewing angle of the photographing device, the photographing device may be unable to find and identify the target object. The sound source positioning technology may find the target object outside the photographing device's perspective through audio and transmit the position/orientation information to the photographing device. For example, the photographing device may be rotated through the gimbal such that the photographing device is able to continue to find and track the target.

The above embodiments are only examples. In actual applications, the fusion processing of Position/orientation 1 and Position/orientation 2 may not be performed, but other methods may be used to track the target object based on Position/orientation 1 and Position/orientation 2.

In the present disclosure, sound positioning technology and image positioning technology may be combined to perform target positioning and tracking, and the tracking targets may include people, animals, objects, etc. that make sounds. The microphone array may be used for sound positioning and image-based feature analysis may be used for image positioning. The positioning results of these two may be used to comprehensively determine the position/orientation of the target object, improving the accuracy and robustness of the positioning results. The method may be applied to any electronic device with data processing functions, and the tracking results may be sent to media apparatuses with recording and photography functions, such as mobile phones, cameras, camcorders, action cameras, gimbal cameras, smart homes, VR/AR equipment or other products, such that the media apparatus adjusts the sound pickup parameters of the sound pickup device and the photographing parameters of the photographing device based on the tracking results, and performs audio and video recording based on the adjusted sound pickup parameters and adjusted photographing parameters. Therefore, audio and video recording effects may be improved. The media apparatus may be a media apparatus in the foregoing media apparatus control method, the relevant content in the embodiment of the target tracking method and the foregoing media apparatus control method may be referenced to each other. In the target tracking method, the image used to determine the first position/orientation information may be the imaging view in the media apparatus control method, and the audio of the target object in the embodiments of the target object tracking method may be the audio emitted by the target audio source in the media apparatus control method.

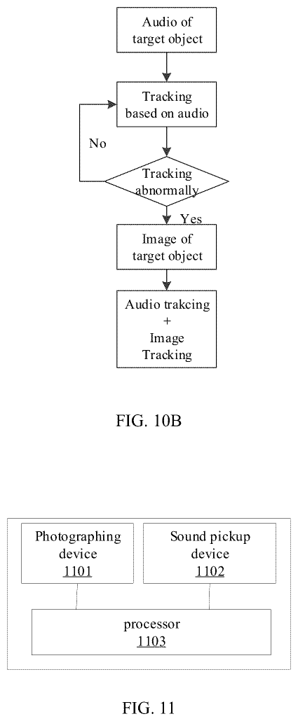

One of the first position/orientation information and the second position/orientation information may be determined based on the image of the target object, and another may be determined based on the audio of the target object. For example, the first position/orientation information may be determined based on the image of the target object, and the second position/orientation information may be determined based on the audio of the target object. Correspondingly, the overall flow chart of the tracking process in the above-described embodiment is shown in FIG. 10A. For another example, the first position/orientation information may be determined based on the audio of the target object, and the second position/orientation information may be determined based on the image of the target object. In this case, the overall flow chart of the tracking process in the above-described embodiment is shown in FIG. 10B. The specific tracking process will be described below, taking the process shown in FIG. 10A as an example.

At 901, the image sent by the photographing device may be obtained, and the first position/orientation information of the target object in space may be determined based on the pixel position of the target object in the image and the attitude information of the photographing device when imaging. Further, the photographing device may collect a video stream of the scene in real time, and the image may include multiple imaging views in the video stream.

The target object may be a specific object with certain features. Specifically, the target object may be an object that satisfies at least one of the following conditions.
(1) The number of pixels the target object occupies in the image satisfies a preset number condition. The preset number condition may be that the number of pixels is larger than a preset quantity threshold, or that the ratio of the number of pixels in the image to the total number of pixels in the image is larger than a preset ratio threshold. Since it is difficult to extract effective visual features for objects that are too small in the image, by using the number of pixels as the condition for determining the target object, only objects that are able to extract effective visual features may be used as target objects and tracked, thereby reducing computing power consumption and improving tracking performance.
(2) Object of a specific category. The specific category may include people, animals, vehicles, etc., and the specific category may be determined according to the actual application scenario. For example, in a traffic management scenario, the target object may be a vehicle. In a scenario with a large flow of people, such as a shopping mall, the target object may be a person.
(3) Object with a specific attribute. The attributes of an object may be determined based on the object's category, and objects of different categories may have different attributes. For example, the attributes of a person may include but are not limited to gender, age, etc., and the attributes of a vehicle may include but are not limited to license plate number, model, etc.

At 902, the target object may be tracked based on the first position/orientation information. For example, in some embodiments, the photographing control information may be sent to the photographing device based on the first position/orientation information, such that the photographing device adjusts the photographing parameters. For another example, the sound pickup control information may be sent to the sound pickup device based on the first position/orientation information, such that the sound pickup device adjusts the sound pickup parameters.

Through the above adjustment, both the photographing device and the sound pickup device may be focused on the target object, therefore improving the tracking accuracy of the target object. For example, the moving speed and moving direction of the target object may be determined based on the first position/orientation information of the target object at multiple times, and the photographing parameters of the photographing device may be adjusted based on the moving speed and moving direction. Adjusting photographing parameters may include but is not limited to adjusting the photographing angle and/or the photographing focal length.

At 903, anomalies may occur during tracking. In some embodiments, the tracking status may be determined to be abnormal when at least any of the following conditions is met: the image quality of the image is lower than a preset quality threshold, the target object is not detected in the image, or the detected target object in the image is incomplete. The image quality may be determined based on parameters such as image clarity, exposure, or brightness. Taking the determination of image quality based on brightness as an example, when the brightness of the image is lower than a preset brightness threshold, it may be determined that the image quality is lower than the preset quality threshold. That the target object is not detected in the image may be because of the fact that the target object moves too fast and the photographing parameters cannot be adjusted in time to focus on the target object. It may also be because of reasons such as the lens of the camera being blocked. The incomplete target object may be caused by the target object being occluded or the target object exceeding the field of view of the photographing device.

To improve the tracking effect, when the tracking status is abnormal, the target object may be tracked based on the image collected by the photographing device and the audio of the target object captured by the sound pickup device at the same time, such that the tracking status may be restored to the normal state. The audio of the target object may be collected and sent by the sound pickup device. The space may include multiple sound sources, and the multiple sound sources may include the target object and objects other than the target object. Therefore, the audio sent by the sound pickup device may include audio of other objects other than the target object. The audio of the target object may be determined based on the audio features of the target object. In some embodiments, the audio of the target object may have at least any one of the following audio features: the audio frequency is within a preset frequency band, the audio amplitude meets the preset amplitude condition, or the preset semantic information is emitted. For specific embodiments of the above audio features, the reference may be made to the aforementioned embodiments of the media apparatus control method, and will not be described again here.

After determining the audio of the target object, the second position/orientation information of the target object may be determined based on the sound pickup parameters when the sound pickup device picks up the audio of the target object (for example, the amplitude and phase of the audio picked up by each microphone in the microphone array included in the sound pickup device). Then, the target object may be re-tracked based on the first position/orientation information and the second position/orientation information together. For example, new sound pickup control information may be sent to the sound pickup device based on the first position/orientation information and the second position/orientation information to control the sound pickup device to refocus on the target object. New camera control information may also be sent to the photographing device based on the first position/orientation information and the second position/orientation information to control the photographing device to refocus on the target object.

There may be different ways to implement the re-tracking. In some embodiments, the first predicted position/orientation of the target object in space may be determined based on the first position/orientation information, and the second predicted position/orientation of the target object in space may be determined based on the second position/orientation information. According to the first predicted position/orientation and the second predicted position/orientation, the area where the target object is located in space may be predicted, to obtain a prediction area. The target object may be tracked based on the prediction area.

For example, the first predicted position/orientation may be determined based on the most recent first position/orientation information obtained one or more times before the target object disappears from the imaging view of the photographing device. The second predicted position/orientation may be determined based on the most recently determined second position/orientation information. The first predicted position/orientation and the second predicted position/orientation may be the same or different. Then, the prediction area may be determined based on the first predicted position/orientation and the second predicted position/orientation. For example, a union of a first area including the first predicted position/orientation and a second area including the second predicted position/orientation may be determined as the prediction area.

During the above re-tracking process, the sound pickup parameters and the photographing parameters may be adjusted to obtain specific effects. For example, the photographing parameters of the photographing device may be adjusted based on the first position/orientation information and the second position/orientation information such that the target object is located in a designated area in the image. For another example, the photographing parameters of the photographing device may be adjusted based on the first position/orientation information and the second position/orientation information, such that the size of the target object in the image matches the distance from the target object to the media apparatus. For another example, the sound pickup parameters of the sound pickup device may be adjusted based on the first position/orientation information and the second position/orientation information, such that the audio matches the distance from the target object to the media apparatus. For another example, the sound pickup parameters of the sound pickup device may be adjusted based on the first position/orientation information and the second position/orientation information to enhance the amplitude of the audio of the target object and weaken the amplitude of other audios except the audio of the target object. For the above process, the reference may be made to the foregoing embodiments of the media apparatus control method, which will not be described again here.

In some embodiments, the audio obtaining may be performed on the target object according to the audio recording mode selected by the user, and/or the image obtaining may be performed on the target object according to the photographing mode selected by the user. Different audio modes may correspond to different adjustment modes of the sound pickup parameters, and different photographing modes may correspond to different adjustment modes of the photographing parameters. For details of the audio recording modes and photographing modes, the reference may be made to the foregoing embodiments of the control method of the media apparatus, which will not be described again here.

In some embodiments, the audio captured by the sound pickup device and the image captured by the photographing device may be out of sync. In this case, the first position/orientation information may be determined based on the most recently obtained image including the target object.

The above embodiments are used as examples to illustrate how to re-track when the tracking status is abnormal when tracking the target object based on the image. How to re-track when the tracking status is abnormal when tracking the target object based on audio of the target object will be described below. The first position/orientation information may be determined based on the audio of the target object, and the second position/orientation information may be determined based on the image of the target object.

The first position/orientation information of the target object may be determined based on the sound pickup parameters when the sound pickup device picks up the audio of the target object (for example, the amplitude and phase of the audio picked up by each microphone in the microphone array included in the sound pickup device). The target object may be determined based on the audio features (audio amplitude, audio frequency, etc.) of the target object. For specific methods, the reference may be made to the foregoing embodiments, which will not be described again here. Then, the target object may be tracked based on the first position/orientation information. For example, the photographing control information may be sent to the photographing device based on the first position/orientation information, such that the photographing device adjusts the photographing parameters. For another example, the sound pickup control information may be sent to the sound pickup device based on the first position/orientation information, such that the sound pickup device adjusts the sound pickup parameters.

During the tracking process, the tracking status may be determined to be abnormal when at least any one of the following conditions is met: the microphones used to collect the audio are at least partially unavailable, or the amplitude of the background noise is larger than a preset amplitude threshold. That at least one microphone is unavailable may be because the at least one microphone is blocked or damaged. The background noise may include, but is not limited to, wind noise. When the tracking status is abnormal, the image of the target object may be further obtained, and the second position/orientation information may be determined based on the image of the target object. For specific methods, the reference may be made to the aforementioned embodiment of determining the first position/orientation information, which will not be described again here. Then, the target object may be tracked based on the first position/orientation information and the second position/orientation information together, that is, the target object may be re-tracked. For example, new sound pickup control information may be sent to the sound pickup device based on the first position/orientation information and the second position/orientation information to control the sound pickup device to refocus on the target object. New camera control information may also be sent to the photographing device based on the first position/orientation information and the second position/orientation information to control the photographing device to refocus on the target object. The specific method of re-tracking can be found in the foregoing embodiments and will not be described again here.

The present disclosure also provides a media apparatus. As shown in FIG. 11, in some embodiments, the media apparatus includes:
a photographing device 1101, configured to capture an environmental image;
a sound pickup device 1102, configured to capture ambient audio; and
a processor 1103, configured to: determine position/orientation information of the target object in the space according to a pixel position of the target object in the environment image;
determine sound source position/orientation information in the space according to the ambient audio; and adjust photographing parameters of the photographing device and sound pickup parameters of the sound pickup device according to the position/orientation information of the target object and the sound source position/orientation information, such that the image captured by the photographing device and the audio picked up by the sound pickup device focus on the target object.

The media apparatus may be a mobile phone, a laptop, a camera with a recording function, etc. The specific details of the photographing device 1101, the sound pickup device 1102 and the processor 1103 may be found in the foregoing embodiments of the media apparatus control method, and will not be described again here.

The present disclosure also provides a control device of a media apparatus. The media apparatus may include a photographing device and a sound pickup device. The control device may include a processor. The processor may be configured to:
determine position/orientation information of the target object in the space according to a pixel position of the target object in the environment image;
determine sound source position/orientation information in the space according to the ambient audio; and
adjust photographing parameters of the photographing device and sound pickup parameters of the sound pickup device according to the position/orientation information of the target object and the sound source position/orientation information, such that the image captured by the photographing device and the audio picked up by the sound pickup device focus on the target object.

In some embodiments, the photographing parameters of the photographing device may be adjusted based on: adjusting the photographing parameters of the photographing device according to the position/orientation information of the target object such that the target object remains in the imaging view; when it is detected that the target object disappears from the imaging view of the photographing device, determining the target sound source position/orientation information associated with the target object based on the ambient audio picked up by the sound pickup device; and adjusting the photographing parameters of the photographing device according to the target sound source position/orientation information, such that the target object reappears in the imaging view of the photographing device.

In some embodiments, the processor may be further configured to: obtain audio feature information of sound sources in the space; and determine the target sound source position/orientation information associated with the target object based on the audio feature information.

In some embodiments, the processor may be further configured to: when the audio characteristic information includes the frequency of audio and the frequency of the audio emitted by a sound source is within a target frequency band range, determine target sound source position/orientation information associated with the target object according to the position/orientation information of the sound source; and/or when the audio feature information includes the amplitude of the audio and the amplitude of the audio emitted by a sound source satisfies a preset amplitude condition, determine target sound source position/orientation information associated with the target object according to the position/orientation information of the sound source; and/or when the audio feature information includes audio semantic information and a sound source emits audio with preset semantic information, determine target sound source position/orientation information associated with the target object according to the position/orientation information of the sound source.

In some embodiments, the photographing device may be used to track and photograph the target object. During the tracking and photographing process, the photographing parameters of the photographing device may be adjusted based on the following method. According to the location information of the target object, the photographing parameters of the photographing device may be adjusted to keep the target object in the imaging view. When it is detected that the target object disappears in the imaging view of the photographing device, the first predicted position/orientation of the target object in space may be determined based on the previous imaging position of the target object in the imaging view, and the second predicted position/orientation of the target object in space may be determined based on the sound source position/orientation information. According to the first predicted position/orientation and the second predicted position/orientation, the photographing parameters of the photographing device may be adjusted, such that the target object reappears in the imaging view of the photographing device.

In some embodiments, the processor may be configured to: predict the area where the target object is located in space according to the first predicted position/orientation and the second predicted position/orientation to obtain a predicted area; and adjust the photographing parameters of the photographing device according to the predicted area.

In some embodiments, the processor may be configured to: adjust the photographing parameters of the photographing device used to collect the image such that the target object is in a designated area in the imaging view; and/or adjust the photographing parameters of the photographing device used to collect the image, such that the size of the target object in the imaging view matches the distance from the target object to the photographing device; and/or adjust the sound pickup parameters of the sound pickup device used to collect the audio such that the audio picked up by the sound pickup device matches the distance from the target object to the sound pickup device; and/or adjust the sound pickup parameters of the sound pickup device used to collect the audio such that the amplitude of the target object's audio is enhanced and the amplitude of audio other than the target object's audio is attenuated.

In some embodiments, the ambient audio captured by the sound pickup device and the image captured by the photographing device may be out of sync. In this case, the imaging position may be determined based on the most recently obtained imaging view including the target object.

In some embodiments, the processor may be configured to: perform the audio obtaining on the target object according to the audio recording mode selected by the user, and adjust the sound pickup parameters of the photographing device in real time according to the target object position/orientation information and the sound source position/orientation information in the photographing mode, and/or perform the image obtaining on the target object according to the photographing mode selected by the user and adjust the photographing parameters of the photographing device in real time according to the target object position/orientation information and the sound source position/orientation information in the photographing mode.

In some embodiments, the processor may be configured to: adjust the sound pickup parameters of the sound pickup device according to the sound source position/orientation information, such that the captured audio is focused on the target object; and, when the position/orientation information of the target object changes, adjust the sound pickup parameters of the sound pickup device based on the changed position/orientation information of the target object, such that the captured audio is refocused on the target object.

In some embodiments, the processor may be configured to adjust the sound pickup parameters of the sound pickup device based on the changed position/orientation information of the target object, such that the captured audio is refocused on the target object, when at least any of the following conditions is met: at least one microphone included in the sound pickup device is unavailable, or the amplitude of the background noise is larger than a preset amplitude threshold.

The present disclosure also provides a tracking device for a target object. The tracking device may include a processor. The processor may be configured to:
determine first position/orientation information of a target object in space;
track the target object according to the first position/orientation information; and
in response to an abnormal tracking status, determine second position/orientation information of the target object in space, and track the target object according to the first position/orientation information and the second position/orientation information, such that the tracking status returns to normal.

One of the first position/orientation information and the second position/orientation information may be determined based on the image of the target object, and another may be determined based on the audio of the target object.

In some embodiments, the first position/orientation information may be determined based on the image of the target object, and the second position/orientation information may be determined based on the audio of the target object. The tracking status may be determined to be abnormal when at least any of the following conditions is met: the image quality of the image is lower than a preset quality threshold, the target object is not detected in the image, or the detected target object in the image is incomplete.

In another embodiment, the first position/orientation information may be determined based on the audio of the target object, and the second position/orientation information may be determined based on the image of the target object. During the tracking process, the tracking status may be determined to be abnormal when at least any one of the following conditions is met: the microphones used to collect the audio are at least partially unavailable, or the amplitude of the background noise is larger than a preset amplitude threshold.

In some embodiments, the target object may meet at least one of conditions including: the audio frequency is within the preset frequency band range, the audio amplitude meets the preset amplitude conditions, the audio emits preset semantic information, or the number of pixels occupied in the image satisfies the preset number conditions.

In some embodiments, the processor may be configured to: determine a first predicted position/orientation of the target object in the space according to the first position/orientation information; determine a second predicted position/orientation of the target object in the space according to the second position/orientation information; and predict the area where the target object is located in space according to the first predicted position/orientation and the second predicted position/orientation to obtain a predicted area; and adjust the photographing parameters of the photographing device according to the predicted area.

In some embodiments, the processor may be configured to: adjust the photographing parameters of the photographing device used to collect the image according to the first position/orientation information and the second position/orientation information such that the target object is in a designated area in the imaging view; and/or adjust the photographing parameters of the photographing device used to collect the image according to the first position/orientation information and the second position/orientation information, such that the size of the target object in the imaging view matches the distance from the target object to the photographing device; and/or adjust the sound pickup parameters of the sound pickup device used to collect the audio according to the first position/orientation information and the second position/orientation information such that the audio picked up by the sound pickup device matches the distance from the target object to the sound pickup device; and/or adjust the sound pickup parameters of the sound pickup device used to collect the audio according to the first position/orientation information and the second position/orientation information such that the amplitude of the target object's audio is enhanced and the amplitude of audio other than the target object's audio is attenuated.

In some embodiments, the ambient audio captured by the sound pickup device and the image captured by the photographing device may be out of sync. In this case, the first position/orientation information may be determined based on the most recently obtained imaging view including the target object.

In some embodiments, the processor may be configured to: perform the audio obtaining on the target object according to the audio recording mode selected by the user, and/or perform the image obtaining on the target object according to the photographing mode selected by the user.

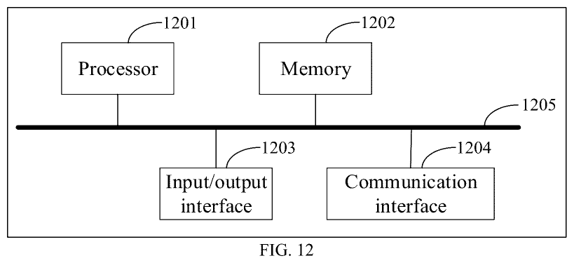

FIG. 12 shows a hardware structure of a control device of a media apparatus or a tracking device of a target object. As shown in FIG. 12, the device includes a processor 1201, a memory 1202, an input/output interface 1203, a communication interface 1204, and a bus 1205.

The processor 1201, the memory 1202, the input/output interface 1203 and the communication interface 1204 may implement communication connections between each other within the device through the bus 1205.

The processor 1201 may be implemented by a general central processing unit (CPU), a microprocessor, an application specific integrated circuit (ASIC), or one or more integrated circuits, and may be configured to execute related programs to implement the technical solutions provided by the embodiments of this specification.

The memory 1202 may be implemented in the form of read only memory (ROM), random access memory (RAM), static storage device, dynamic storage device, etc. The memory 1202 may be configured to store operating systems and other application programs. When implementing the technical solutions provided in the embodiments of this specification through software or firmware, the relevant program codes may be stored in the memory 1202 and called and executed by the processor 1201.

The input/output interface 1203 may be configured to connect input/output modules to realize information input and output. The input/output/module may be disposed in the device as a component (not shown in the figure), or may be externally connected to the device to provide corresponding functions. Input devices may include keyboards, mice, touch screens, microphones, various sensors, etc., and output devices may include monitors, speakers, vibrators, indicator lights, etc.

The communication interface 1204 may be used to connect a communication module (not shown in the figure) to realize communication interaction between this device and other devices. The communication module may communicate through wired modes (such as USB, network cable, etc.) or wireless modes (such as mobile network, WIFI, Bluetooth, etc.).

The bus 1205 may include a path that carries information between various components of the device (e.g., the processor 1201, the memory 1202, the input/output interface 1203, and the communication interface 1204).

Although the above device only shows the processor 1201, the memory 1202, the input/output interface 1203, the communication interface 1204 and the bus 1205, the device may include one or more of each of these components, and may also include other needed components to achieve normal operation. In addition, those skilled in the art may understand that the above-mentioned device may only include components needed to implement the embodiments of this specification, and does not necessarily include all components shown in the drawings.

The present disclosure also provides a computer-readable storage medium. The computer-readable storage medium may be configured to store a computer program. When the computer program is executed by a processor, the method provided by various embodiments of the present disclosure may be implemented.

The computer-readable media may include volatile or non-volatile, removable or non-removable media that may be implemented by any method or technology for storage of information. Information may be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic tape cassettes, tape magnetic disk storage or other magnetic storage devices or any other non-transmission medium that is able to store information accessible by a computing device.

All or part of the above embodiments in the present disclosure may be implemented through a combination of software and a general hardware platform. All or part of the above embodiments may be implemented as a software product. The software product may be stored in a storage medium, and may include instructions that may make a computer device (such as a personal computer, a server, or a network device) to implement the above-mentioned method provided by various embodiments of the present disclosure. The storage medium may be a magnetic disk, an optical disk, a read-only memory (ROM) or a random access memory (RAM), and the like.

The systems, devices, modules or units described in the above embodiments may be implemented by computer chips or entities, or by products with certain functions. A typical implementation device is a computer, which may be in the form of a personal computer, a laptop, a cellular phone, a camera phone, a smart phone, a personal digital assistant, a media player, a navigation device, an email transceiver, or a game controller, a desktop, a tablet, a wearable device, or a combination of any of these devices.

The various technical features in the above embodiments can be combined arbitrarily, as long as there is no conflict or contradiction between the combinations of features. However, due to space limitations, they are not described one by one. Therefore, the various technical features in the above embodiments can be combined arbitrarily. also fall within the scope of this disclosure.

The terminology used in the present disclosure is for the purpose of describing particular embodiments only and is not intended to limit the scope of the present disclosure. The term “and/or” used in the present disclosure and the appended claims refers to any combination of one or more of the associated listed items and all possible combinations, and includes these combinations.

The above are only specific implementations of embodiments of the present disclosure, but the scope of the present disclosure is not limited to this. One of ordinary skill in the art can easily think of various equivalents within the technical scope disclosed in the present disclosure. These modifications or replacements shall be included within the scope of the present disclosure. Therefore, the protection scope of the present invention shall be subject to the protection scope of the claims.

What is claimed is:

1. A control method comprising:
determining position/orientation information of a target object according to an imaging position of the target object in an imaging view of a photographing device of a media apparatus;
determining sound source position/orientation information according to ambient audio picked up by a sound pickup device of the media apparatus; and
adjusting a photographing parameter of the photographing device and a sound pickup parameter of the sound pickup device according to the position/orientation information of the target object and the sound source position/orientation information, to focus an image captured by the photographing device and audio picked up by the sound pickup device on the target object.

2. The method according to claim 1, wherein adjusting the photographing parameter includes:
adjusting the photographing parameter according to the position/orientation information of the target object to keep the target object in the imaging view.

3. The method according to claim 2, wherein adjusting the photographing parameter according to the position/orientation information of the target object to keep the target object in the imaging view includes:
in response to detecting that the target object disappears from the imaging view of the photographing device:
determining target sound source position/orientation information associated with the target object according to the ambient audio picked up by the sound pickup device; and
adjusting the photographing parameter of the photographing device according to the target sound source position/orientation information, to cause the target object to return to the imaging view of the photographing device; or
in response to detecting that the target object disappears from the imaging view of the photographing device:
determining a first predicted position/orientation of the target object according to the imaging position of the target object in the imaging view before the target object disappears from the imaging screen;
determining a second predicted position/orientation of the target object according to the sound source position/orientation information; and
adjusting the photographing parameter according to the first predicted position/orientation and the second predicted position/orientation, to cause the target object to return to the imaging view.

4. The method according to claim 3, wherein determining the target sound source position/orientation information includes:
obtaining audio feature information of sound sources; and
determining the target sound source position/orientation information based on the audio feature information.

5. The method according to claim 4, wherein determining the target sound source position/orientation information based on the audio feature information includes at least one of:
in response to a frequency of audio emitted by one of the sound sources is within a target frequency band, determining the target sound source position/orientation information based on position/orientation information of the one of the sound sources;
in response to an amplitude of audio emitted by one of the sound sources meets a preset amplitude condition, determining the target sound source position/orientation information based on position/orientation information of the one of the sound sources; or
in response to one of the sound sources emitting audio with preset semantic information, determining the target sound source position/orientation information based on position/orientation information of the one of the sound sources.

6. The method according to claim 3, wherein adjusting the photographing parameter according to the first predicted position/orientation and the second predicted position/orientation includes:
predicting where the target object is located according to the first predicted position/orientation and the second predicted position/orientation to obtain a predicted area; and
adjusting the photographing parameter of the photographing device according to a position/orientation of the predicted area.

7. The method according to claim 1, wherein adjusting the photographing parameter of the photographing device and the sound pickup parameter of the sound pickup device includes at least one of:
adjusting the photographing parameter to cause the target object to be in a specified area in the imaging view;
adjusting the photographing parameter to cause a size of the target object in the imaging view to match a distance from the target object to the media apparatus;
adjusting the sound pickup parameter to cause the audio picked up by the sound pickup device to match the distance from the target object to the media apparatus; or
adjusting the sound pickup parameter to enhance an amplitude of the audio of the target object and weaken an amplitude of other audio except the audio of the target object.

8. The method according to claim 1, further comprising:
in response to the imaging view being not synchronized with the ambient audio, determining the imaging position based on a most recently obtained imaging view including the target object.

9. The method according to claim 1, wherein adjusting the photographing parameter and the sound pickup parameter includes at least one of:
performing audio recording on the target object based on a recording mode selected by a user, and, in the recording mode, adjusting the sound pickup parameter in real time according to the position/orientation information of the target object and the sound source position/orientation information; or
photographing the target object based on a photographing mode selected by the user, and, in the photographing mode, adjusting the photographing parameter in real time according to the position/orientation information of the target object and the sound source position/orientation information.

10. The method according to claim 1, wherein adjusting the photographing parameter and the sound pickup parameter includes:
adjusting the sound pickup parameter according to the sound source position/orientation information to focus picked-up audio picked up by the sound pickup device on the target object; and
in response to the position/orientation of the target object changing, adjusting the sound pickup parameter based on changed position/orientation information of the target object to refocus the picked-up audio on the target object.

11. The method according to claim 10, wherein adjusting the sound pickup parameter based on the changed position/orientation information of the target object to refocus the picked-up audio on the target object in response to the position/orientation information of the target object changing is performed in response to at least one of following conditions is met:
at least one microphone of the sound pickup device is unavailable, and
an amplitude of background noise is greater than a preset amplitude threshold.

12. A control device comprising:
at least one processor; and
at least one memory storing at least one computer program that, when executed by the at least one processor, causes the control device to:
determine position/orientation information of a target object according to an imaging position of the target object in an imaging view of a photographing device of a media apparatus;
determine sound source position/orientation information according to ambient audio picked up by a sound pickup device of the media apparatus; and
adjust a photographing parameter of the photographing device and a sound pickup parameter of the sound pickup device according to the position/orientation information of the target object and the sound source position/orientation information, to focus an image captured by the photographing device and audio picked up by the sound pickup device on the target object.

13. The device according to claim 12, wherein the at least one computer program, when executed by the at least one processor, further causes the control device to adjust the photographing parameter by:
adjusting the photographing parameter according to the position/orientation information of the target object to keep the target object in the imaging view.

14. The device according to claim 13, wherein the at least one computer program, when executed by the at least one processor, further causes the control device to adjust the photographing parameter according to the position/orientation information of the target object to keep the target object in the imaging view by:
in response to detecting that the target object disappears from the imaging view of the photographing device:
determining target sound source position/orientation information associated with the target object according to the ambient audio picked up by the sound pickup device; and
adjusting the photographing parameter of the photographing device according to the target sound source position/orientation information, to cause the target object to return to the imaging view of the photographing device; or
in response to detecting that the target object disappears from the imaging view of the photographing device:
determine a first predicted position/orientation of the target object according to the imaging position of the target object in the imaging view before the target object disappears from the imaging screen;
determine a second predicted position/orientation of the target object according to the sound source position/orientation information; and
adjust the photographing parameter according to the first predicted position/orientation and the second predicted position/orientation, to cause the target object to return to the imaging view.

15. The device according to claim 12, wherein the at least one computer program, when executed by the at least one processor, further causes the control device to perform at least one of:
adjusting the photographing parameter to cause the target object to be in a specified area in the imaging view;
adjusting the photographing parameter to cause a size of the target object in the imaging view to match a distance from the target object to the media apparatus;
adjusting the sound pickup parameter to cause the audio picked up by the sound pickup device to match the distance from the target object to the media apparatus; or
adjusting the sound pickup parameter to enhance an amplitude of the audio of the target object and weaken an amplitude of other audio except the audio of the target object.

16. The device according to claim 12, wherein the at least one computer program, when executed by the at least one processor, further causes the control device to:
in response to the imaging view being not synchronized with the ambient audio, determining the imaging position based on a most recently obtained imaging view including the target object.

17. The device according to claim 12, wherein the at least one computer program, when executed by the at least one processor, further causes the control device to perform at least one of:
performing audio recording on the target object based on a recording mode selected by a user, and, in the recording mode, adjusting the sound pickup parameter in real time according to the position/orientation information of the target object and the sound source position/orientation information; or
photographing the target object based on a photographing mode selected by the user, and, in the photographing mode, adjusting the photographing parameter in real time according to the position/orientation information of the target object and the sound source position/orientation information.

18. The device according to claim 12, wherein the at least one computer program, when executed by the at least one processor, further causes the control device to:
adjust the sound pickup parameter according to the sound source position/orientation information to focus picked-up audio picked up by the sound pickup device on the target object; and
in response to the position/orientation of the target object changing, adjust the sound pickup parameter based on changed position/orientation information of the target object to refocus the picked-up audio on the target object.

19. The device according to claim 18, wherein the at least one computer program, when executed by the at least one processor, further causes the control device to adjust the sound pickup parameter based on the changed position/orientation information of the target object to refocus the picked-up audio on the target object in response to the position/orientation information of the target object changing is performed in response to at least one of following conditions is met:
at least one microphone of the sound pickup device is unavailable, and
an amplitude of background noise is greater than a preset amplitude threshold.

20. A media apparatus comprising:
at least one photographing device configured to collect an ambient image;
at least one sound pickup device configured to pick up ambient audio;
at least one processor; and
at least one memory storing at least one computer program that, when executed by the at least one processor, causes the apparatus to:
determine position/orientation information of a target object according to an imaging position of the target object in an imaging view of the photographing device;
determine sound source position/orientation information according to the ambient audio picked up by the sound pickup device; and
adjust a photographing parameter of the photographing device and a sound pickup parameter of the sound pickup device according to the position/orientation information of the target object and the sound source position/orientation information, to focus an image captured by the photographing device and audio picked up by the sound pickup device on the target object.
